(19) United States
(12) Patent Application Publication
(10) Pub. No.: US 2015/0091910 A1
(43) Pub. Date: Apr. 2, 2015

(54) CLIENT AND IMAGE DATA GENERATING METHOD

(71) Applicant: Azbil Corporation, Tokyo (JP)

(72) Inventor: Takeshi KURUMISAWA, Tokyo (JP)

(73) Assignee: Azbil Corporation, Tokyo (JP)

(21) Appl. No.: 14/497,599

(22) Filed: Sep. 26, 2014

(30) Foreign Application Priority Data
Sep. 27, 2013 (JP) 2013-201744

(51) Int. Cl. G06T 11/20

(52) U.S. Cl. CPC G06T 11/206
USPC 345/440

(57) ABSTRACT

A client includes an information generating portion that generates first information for defining a correspondence between a measurement result by a measuring instrument and a calculating procedure executed using the measurement result, and generates second information for defining correspondence relationships between the calculating procedure and the calculation results of the calculating procedure, and an image data generating portion that generates image data for displaying an image that defines the relationship between the first information and the second information.

### CROSS REFERENCE TO RELATED APPLICATION

This application claims priority under 35 U.S.C. §119 to Japanese Patent Application No. 2013-201744, filed on Sep. 27, 2013, the entire content of which being hereby incorporated herein by reference.

### FIELD OF TECHNOLOGY

The present invention relates to a method for generating client and image data by synthesizing image data for displaying an image corresponding to a plurality of information.

Conventionally, there have been known plant data calculating/saving processing devices for performing prescribed calculations using data obtained from a plant, or the like, for performing procedures to accumulate the calculation results, for performing fixed format output procedures, and the like. See, for example, Japanese Unexamined Patent Application Publication No. H10-320038 (“the JP '038”).

Moreover, the plant data calculating/saving processing device set forth in, for example, Japanese Unexamined Patent Application Publication No. 2007-34516 (“the JP '516”) comprises: an engineering tool having a calculating formula table editing portion for editing a calculating formula table, a calculation result table initializing portion for initializing a calculation result table in accordance with the edited calculating formula table, and a table transmitting portion for transmitting the edited calculating formula table and initialized calculation result table; and a plant data calculating/saving server having a new table saving portion for saving the calculating formula table and calculation result table transmitted by the engineering tool, a existing table saving portion for saving the calculating formula table and the calculation result table that are operating at the present point in time, a corrected calculating formula detecting portion for detecting a calculating formula that has been corrected, through comparing the calculation formula table of the new table saving portion and the calculating formula table of the existing table saving portion, a calculation result table updating portion for replacing, with the calculation result table saved in the new table saving portion, only that part of the calculation result table of the existing table saving portion corresponding to calculating formulas detected as having been corrected, and a calculating formula table updating portion for replacing the calculating formula table of the existing table saving portion with the calculating formula table of the new table saving portion.

However, in the plant data calculating/saving processing devices set forth in the JP '038 and the JP '516 above, when problems arise such as errors in the calculating formulas or illegal input signals, or the like, after the prescribed calculations have been performed and saved using data obtained from a plant or the like, a great amount of labor is required in the work of analyzing the problem, and tracing back the causes requires a great amount of time.

Several aspects of the present invention are the result of contemplation on this issue, and are to provide client and image data generating methods wherein the work in analyzing the problem is easy when there is an ever in a calculating formula or an illegal input signal, and where in the cause can be traced back rapidly.

### SUMMARY

In order to solve the problem set forth above, a client according to the present invention includes: an information generating portion that generates first information for defining a correspondence between a measurement result by a measuring instrument and a calculating procedure executed using the measurement result, and generates second information for defining correspondence relationships between the calculating procedure and the calculation results of the calculating procedure; and an image data generating portion that generates image data for displaying an image that defines the relationship between the first information and the second information.

Moreover, an image data generating method according to the present invention includes the steps of: generating first information that defines a correspondence between a measurement result by a measuring instrument and a calculating procedure executed using the measurement result, and generating second information for defining a correspondence between the calculating procedure and the calculation result by the calculating procedure; and generating image data for displaying an image that defines the relationship between the first information and the second information.

The present invention enables visualization of relationships between measurement results used in calculating procedures and calculation results obtained from the calculating procedures, and visualization of the state of occurrence of problems such as errors in calculating formulas and illegal input signals, and the like, through displaying an image that shows the correspondence of data on the correspondence between measurement results of measurement instruments and calculating procedures executed using those measurement results, and data regarding correspondence between calculating procedures and calculation results of those calculating procedures. As a result, the problem analysis work becomes simple and tracing back of causes can be done rapidly.

### BRIEF DESCRIPTIONS OF THE DRAWINGS

FIG. 1 is a diagram illustrating the overall structure of a system relating to Example according to the present invention.

FIG. 2 is a block diagram illustrating the key structures of the client computer, server computer, and control system GW shown in FIG. 1.

FIG. 3 is a diagram showing time series data wherein measurement results of the measurement instruments relating to the Example according to the present invention are arranged in a time series.

FIG. 4 is a diagram illustrating details of procedures in a client computer and a server computer relating to the Example according to the present invention.

FIG. 5 is a diagram illustrating data that defines correspondence between measured values of measurement instruments relating to the Example according to the present invention and calculating procedures that are executed using those measured values.

FIG. 6 is a diagram illustrating data selling the correspondence between the calculating procedures relating to the Example according to the present invention and the calculation results of the calculating procedures.

FIG. 7 is a flowchart illustrating a flow for displaying image data relating to the Example according to the present invention.

FIG. 8 is a diagram illustrating an image display of image data relating to the Example according to the present invention.

### DETAILED DESCRIPTION

An example of the present invention will be explained below in reference to the appended drawings. For ease in understanding, identical structural elements in the various drawings are assigned identical codes whenever possible, and redundant explanations are omitted.

### EXAMPLE

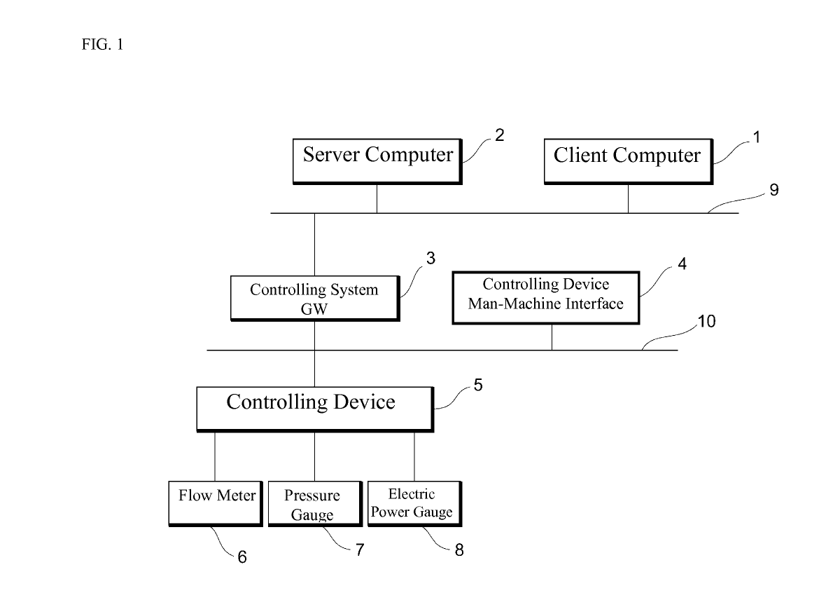

First, the overall structure of a system according to an example according to the present invention will be explained in reference to FIG. 1. FIG. 1 is a diagram illustrating the overall structure of a system relating to Example according to the present invention.

As illustrated in FIG. 1, the system relating to the Example according to the present invention includes: a client computer 1, a server computer 2, a control system GW (gateway) 3, a controlling device man-machine interface 4, a controlling device 5, a flow meter 6, a pressure gauge 7, and an electric power gauge 8.

The flow meter 6, the pressure gauge 7, and the electric power gauge 8 are measuring instruments that are disposed within the plant. Along with these measuring instruments, instruments that offer the HART (Highway Addressable Remote Transducer) communication function and instruments compatible with Foundation™ Fieldbus (FF) can be used.

The flow meter 6, the pressure gauge 7, and the electric power gauge 8 perform measurement procedures. The flow meter 6 measures the flow rate of a fluid, such as water, the pressure gauge measures the pressure of the flow of the fluid, such as water, and the electric power gauge 8 measures the electric power of the instruments that perform prescribed procedures within the plant or workplace. For example, when performing an electric power energy converting procedure in an office building, which is one type of workplace, the electric power gauges 8 that are disposed on each of the floors of the office building measure the electric power, which is the result of the electric power energy converting procedure, or the like, that is, measures the electric power that is generated when processing the electric power energy converting procedure, or the like.

While here a flow meter 6, a pressure gauge 7, and an electric power gauge 8 were listed by way of illustration, they may instead be various types of sensor instruments for detecting temperature, or the like, valve positioners for controlling various types of valves, such as flow rate control valves or pressure control valves, various types of actuators that cause pumps, fans, and the like to operate, and so forth.

The controlling device 5 is connected to the flow meter 6, the pressure gauge 7, and the electric power gauge 8 through various types of signal lines, to acquire the measurement results by the measuring instruments, that is, the flow rate of the fluid, the pressure of the fluid flow, and the electric power (measured value) of the instrument that performs the prescribed procedure in the plant or workplace. Moreover, it also acquires information for identifying the measuring instrument and information for identifying the procedure in the measurement procedure.

The controlling device man-machine interface 4 is connected through a control system network 10 to the control system GW 3 and the controlling device 5, and fulfills the role as interfaces between the manager who is managing the plant and the various types of devices that structure the system relating to this example according to the present invention.

The server computer 2 can be connected to the control system network 10 through the control system GW 3, and with prescribed periods, or with an arbitrary timing, collects information (measuring instrument information) such as measurement results by the measuring instruments, information for identifying the measuring instruments, information for identifying the measuring procedure, and the like. Moreover, although described in detail below, the server computer 2 executes calculating procedures using the measuring instrument information, and stores the various types of data generated through the calculating procedures.

The client computer 1 is connected to the server computer 2 through a higher-level system network 9. Additionally, although described in detail below, the client computer 1 generates image data for displaying an image, from various types of data generated by the server computer 2 and sent from the server computer 2, to display an image.

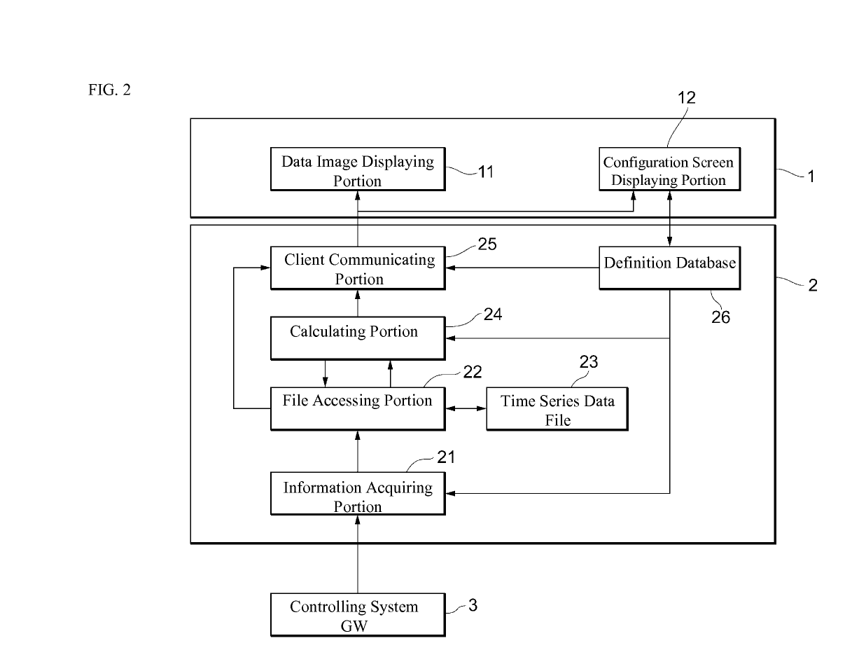

FIG. 2 is a block diagram illustrating the key structures of the client computer 1, the server computer 2, and the control system GW 3 that are illustrated in FIG. 1.

As illustrated in FIG. 2, the client computer 1 is provided with a data image displaying portion 11 and a configuration screen displaying portion 12. Moreover, the server computer 2, functionally, is provided with an information acquiring portion 21, a file accessing portion 22, a time series data file 23, a calculating portion 24, a client communication [processing portion] 25, and a definition database 26.

First, as illustrated in FIG. 2, the information acquiring portion 21 of the server computer 2 awaits the arrival of the collection time for collecting information from the flow meter 6, the pressure gauge 7, and the electric power gauge 8 (the measuring instruments) through the controlling system GW 3. Note that the collection of the measuring instrument information may be performed on a regular periodic basis in units of hours or units of days, or even units of seconds, units of minutes, units of weeks, units of months, or units of years. The structure may also be one wherein the measuring instrument information is collected with an arbitrary timing, unrelated to the “collection time.”

The information acquiring portion 21 of the server computer 2 next collects the measuring instrument information through the control system GW 3 at the collection time or with arbitrary timing.

Following this, the information acquiring portion 21 of the server computer 2 outputs, to the file accessing portion 22, the measuring instrument information collected for the flow meter 6, the pressure gauge 7, and the electric power gauge 8.

Following this, the file accessing portion 22 receives the measuring instrument information for the flow meter 6, the pressure gauge 7, and the electric power gauge 8, outputted by the information acquiring portion 21. Furthermore, the information acquiring portion 21 and/or the file accessing portion 22 outputs the measuring instrument information to a time series data file 23 that stores this information in a time series, to store the measuring instrument information in the time series data file 23. Note that the information acquiring portion 21 and the file accessing portion 22 may work together to store the measuring instrument information in the time series data file 23.

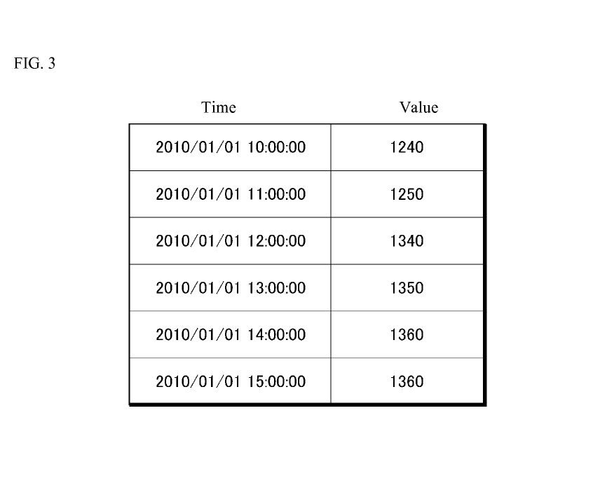

Specifically, of the measuring instrument information collected by the information acquiring portion 21, specific measured values are stored as a time series, as illustrated in FIG. 3, so as to show the correspondence between the measured values and the measurement times, where, for example, the value corresponding to Jan. 1, 2010, 12:00:00 is “1340.” That is, this indicates that the measurement value that was measured by the measuring instrument at 12:00:00 on Jan. 1, 2010 was “1340.” Note that while six time series data are illustrated in FIG. 3, this is no more than one example, and in practice a vast amount of measuring instrument information is collected by the information acquiring portion 21 and the measuring instrument information is outputted to the time series file 23 by the information acquiring portion 21 and/or the file accessing portion 22, to be stored in the time series data file 23.

Moreover, the measuring instrument information collected by the information acquiring portion 21 of the server computer 2 is tagged (given a correspondence) and stored in the time series file 23, to facilitate easy management.

Following this, the calculating portion 24 of the server computer 2, as illustrated in FIG. 2, accesses the time series data file 23 through the file accessing portion 22 to acquire the measuring instrument information that has been stored in the time series data file 23, to perform calculations. After the calculations, the calculating portion 24 outputs the calculation results to the client communication processing portion 25, or to the time series data file 23, again through the file accessing portion 22. Given this, when the calculation results are stored in the time series data file 23, the calculation results are stored corresponding to the calculating procedures, as explained above.

Next, as illustrated in FIG. 2, the client communicating portion 25 of the server computer 2 receives various types of data calculated by the calculating portion 24. It also acquires, through the file accessing portion 22, various types of data stored in the time series data file 23. Furthermore, the client communicating portion 25 transmits, to the client computer 1, the various types of data generated by the calculating portion 24. Note that the client communicating portion 25 transmits, to the client computer 1, the various types of data that are stored in the time series data file 23.

Following this, as illustrated in FIG. 2, the data image displaying portion 11 of the client computer 1 receives the various types of data calculated by the calculating portion 24 and transmitted by the client communicating portion 25 of the server computer. Given this, although the details are described below, the client computer 1 generates, from the various types of data that have been received, data corresponding to the various types of data, and generates image data from the data corresponding to the various types of data that have been generated. Additionally, the data image displaying portion 11 displays an image that is generated from the image data.

Moreover, as illustrated in FIG. 2, the configuration screen displaying portion 12 of the client computer 1 displays a configuration screen for setting up the operation definitions for the various types of devices, instruments, or processing portions provided in the system relating to the present example.

The manager (user) of the plant, workplace, or the like uses this configuration screen to set up the operation definitions for the various processing portions provided in this system. For example, the user, in the configuration screen of the configuration screen displaying portion 12, sets up the procedural details of the procedure for collecting the measurement instrument information to be executed by the information acquiring portion 21 of the server computer 2. Moreover, the user also sets up the procedural details for the calculating procedures to be executed by the calculating portion 24. Furthermore, the user sets up the procedural details for the procedure for receiving and outputting various types of information and image data, executed by the client communicating portion 25.

Note that the procedural details of the data generating procedure for the data corresponding to the various types of data, and the procedural details for the image data generating procedures, executed by the client computer 1, may also be set up here.

Moreover, the configuration screen displaying portion 12 transmits, to a definition database 26 of the server computer 2, information regarding the operation definitions that have been set up. The definition database 26 receives and stores the information that has been transmitted regarding the operation definitions.

Note that the user, in the configuration screen of the configuration screen displaying portion 12 of the client computer 1, is able to reset or redefine the operation definitions stored in the definition database 26 of the server computer 2. Moreover, while, in the present example, the definition database 26 is provided in the server computer 2, as illustrated in FIG. 2, it may instead be provided in the client computer 1.

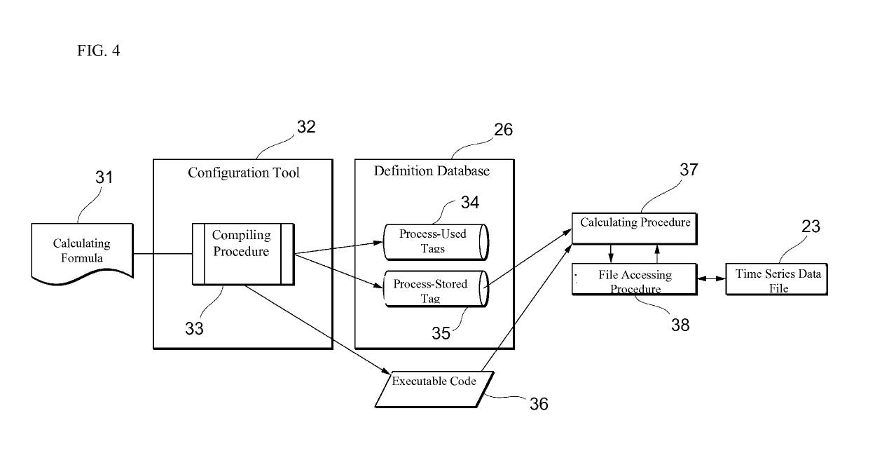

FIG. 4 is a diagram illustrating the procedural detail for the client computer 1 and the server computer 2 according to the Example according to the present invention.

As illustrated in FIG. 2 and FIG. 4, the client computer 1 first inputs a calculating formula 31. Following this, the client computer 1, in the configuration tool 32 (not shown in FIG. 2), performs a compiling procedure 33. Specifically, in the compiling procedure 33, when the calculating procedure is to be performed on the measuring instrument information, collected by the information acquiring portion 21 of the server computer 2, using a prescribed program language, performs syntactic analysis, using a syntactic analytical method through, for example, the LR (left-to-right scanning right-most derivation) method on the measuring instrument information to change into a format whereby the calculating procedure can be performed.

Additionally, in the configuration tool 32 of the client computer 1, the information on which the compiling procedure 32 has been performed is tagged and stored in the definition database 26 of the server computer 2. Specifically, the configuration tool 32 of the client computer 1 generates, and stores in the definition database 26, data for defining the correspondence between measured values and calculating procedures performed using those measured values (“first information”) (the procedure-used tag 34 in FIG. 4), for the measurement instrument information collected by the information acquiring portion 21 of the server computer 2. Moreover, the configuration tool 32), for the measurement instrument information collected by the information acquiring portion 24 of the server computer 2. Moreover, the data that is used when the calculating portion 24 performs the calculating procedure is data that is stored in the time series data file 23. Note that the first information, second information, and other information generated by the configuration tool 32 has referenced and non-referenced [sic—probably a typographical error for “referencer and referencee”] relationships.

Furthermore, executable code 36 is generated by the configuration tool 32 of the client computer 1. The server computer 2 executes this executable code 36 either at regular periods or with arbitrary timing. The calculation result of the calculating procedure 37, executed by the server computer 2 is stored in the time series data file 23 through performing a file accessing procedure 38. The executable code 36 may be provided in the client computer 1 or may be provided in the server computer 2.

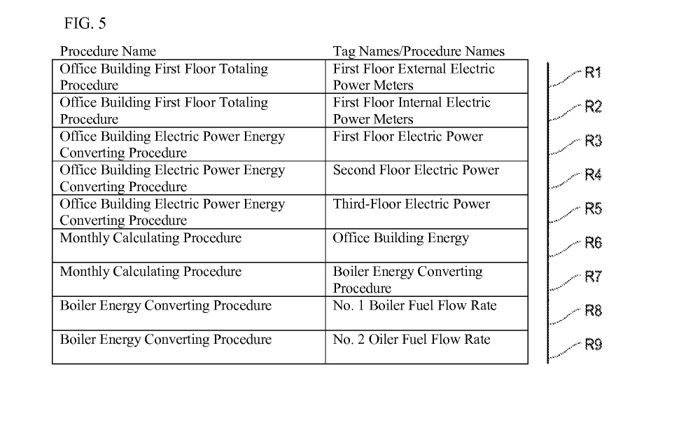

FIG. 5 is a diagram illustrating data wherein relationships are defined between the measured values for the measuring instruments relating to the Example according to the present invention and the calculating procedures executed using those measured values.

As illustrated in FIG. 5, when the calculating portion 24 of the server computer 2 is to execute an office building first floor totaling procedure using the measured values from external electric power gauges, disposed on the first floor of an office building, the configuration tool 32 of the client computer 1 defines a correspondence between the measured values of the external electric power gauges that are disposed on the first floor of the office building and the office building first floor electric power totaling procedure that is executed using those measured values, to generate correspondence data (R1, shown in FIG. 5) between the names of the external electric power gauges that are disposed in the office building first floor, and the name of the office building first floor electric power totaling procedure.

Moreover, although not shown, if the instrument that executes the electric power energy converting procedure executes the office building electric power energy converting procedure using the electric power measured by the office building first floor electric power gauges and that electric power, the configuration tool 32 of the client computer 1 generates data (R3, shown in FIG. 5) defining the correspondence between the electric power measured by the electric power gauges in the office building first floor, used in the office building electric power energy converting procedure, and the name of the office building electric power energy converting procedure.

Moreover, although not illustrated, if the instrument that executes a boiler energy converting procedure executes a monthly calculating procedure by executing the boiler energy converting procedure, with the calculating portion 24 using the procedure result, obtained from the boiler energy converting procedure, and that procedure result, then the client computer 1 configuration tool 32 generates data (R7, shown in FIG. 5) for defining a correspondence between the name of the boiler energy converting procedures and the names of the monthly calculating procedures. Note that data other than R1, R3, and R7, shown in FIG. 5, is generated similarly.

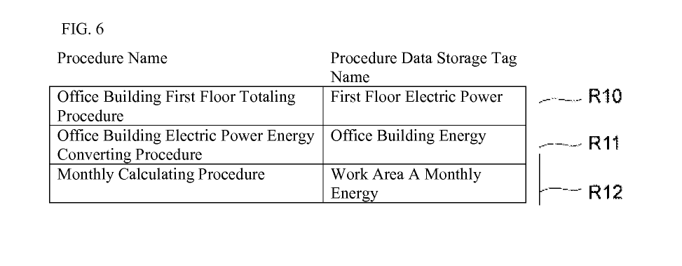

FIG. 6 is a diagram illustrating the data for assigning correspondence between the calculating procedures relating to the Example according to the present invention and the calculation results of the calculating procedures.

If the calculating portion 24 executes the calculating procedure for finding the total electric power for the first floor of the office building, the office building first floor total electric power is produced. In this case, the configuration tool 32 of the client computer 1, as illustrated in FIG. 6, generates data (R10, shown in FIG. 6) defining the correspondence between the name of the office building first floor electric power total calculating procedure and the name of the calculation result obtained through this procedure. Note that data other than R11 and R12, shown in FIG. 6, is generated similarly.

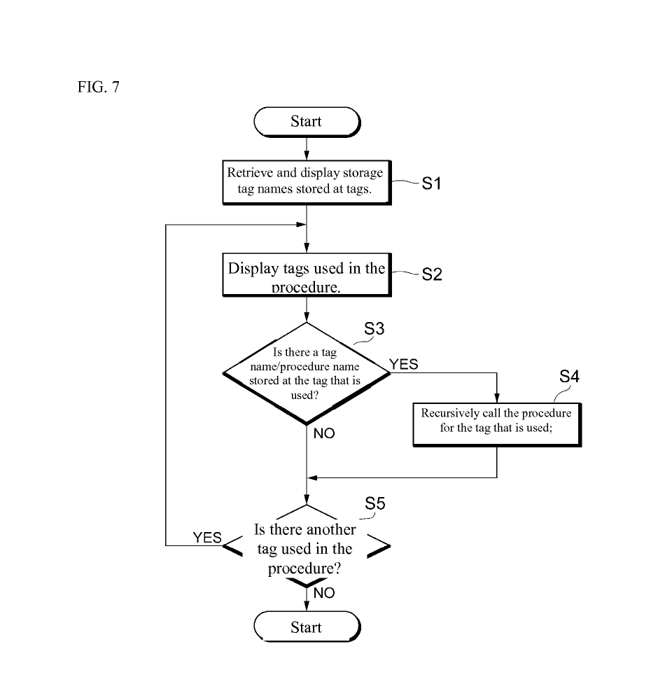

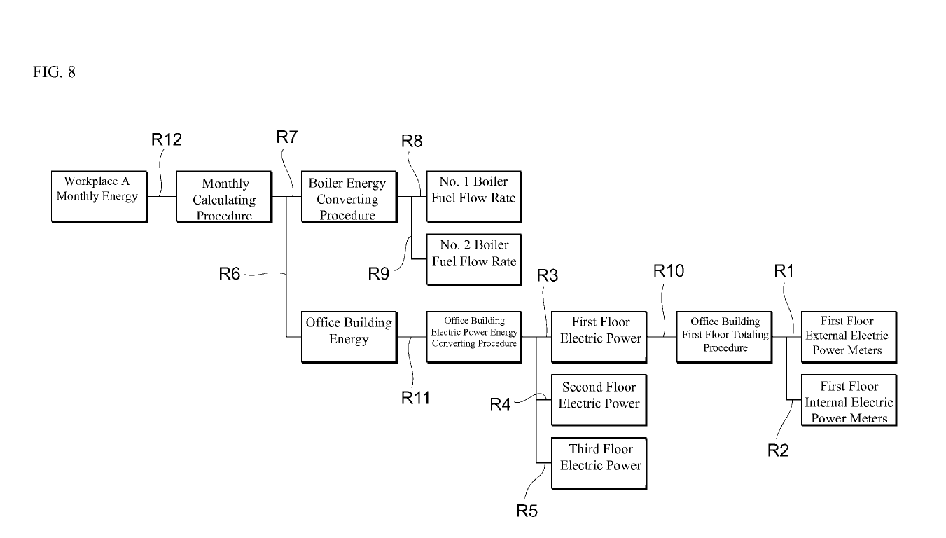

FIG. 7 is a flowchart showing the flow in displaying image data relating to the Example according to the present invention. FIG. 8 is a diagram showing the image display of the image data relating to the Example according to the present invention.

If a user wishes to understand what types of calculating procedures, calculation results, and measuring instrument information are used in “workplace A monthly energy,” then first the client computer 1 searches for the storing tag name “workplace A monthly energy,” stored at the data storing tag illustrated in FIG. 6, to be displayed by the data image displaying portion 11 of the client computer 1, shown in FIG. 2 (S1, shown in FIG. 7).

Following this, the client computer 1 displays the tag (the “Monthly Calculating Procedure” shown in FIG. 6) used by the calculating procedure that is executed in order to obtain the “workplace A monthly energy,” illustrated in FIG. 6. The result is that the relationship R12 in FIG. 6 is displayed on the data image displaying portion 11, as shown in FIG. 8.

Following this, the client computer 1 evaluates whether or not there is a tag name/procedure name stored for the tag that is used (S3, shown in FIG. 7).

If there is a tag name/procedure name that is stored at the tag that is used, then the client computer 1 recursively retrieves the procedures corresponding to the tag that is used (S4, illustrated in FIG. 7). Specifically, as indicated by the relationships R6 and R7, shown in FIG. 5, it retrieves the tag names/procedure names used by the “Monthly Calculating Procedure” (the “boiler energy converting procedure” and the “office building energy”), and displays the tag names/procedure names that have been found. As a result, following the relationship of R12, the relationships R6 and R7 are displayed in the data image displaying portion 11, as illustrated in FIG. 8.

If there is no tag name/procedure name stored at the tag that is used, or if S4, shown in FIG. 7, has been executed, then the client computer 1 evaluates whether or not there are other tags that are used by the procedure (S5, shown in FIG. 7). If there is another tag used in the procedure, then processing returns to S2, shown in FIG. 7, and continues from there. Moreover, if there is no other tag used in the procedure, then processing is terminated.

Specifically, the tags used in the “boiler energy converting procedure” of FIG. 5, shown above, are the “No. 1 fuel flow rate” and “No. 2 fuel flow rate” tags in FIG. 5. Given this, the client computer 1 displays the relationships R8 and R9 on the data image displaying portion 11, as illustrated in FIG. 8, between the “boiler energy converting procedure” in FIG. 5 and the “No. 1 fuel flow rate,” and between the “boiler energy converting procedure” and the “No. 2fuel flow rate.”

Moreover, as illustrated in FIG. 6, the procedure that is executed in order to obtain the “office building energy” is the “office building electric power energy converting procedure,” and the relationship is shown by R11. Given this, the client computer 1 displays, on the data image displaying portion 11, this relationship with R11, as illustrated in FIG. 8.

Furthermore, following the procedures explained above, the client computer 1 displays, as illustrated in FIG. 8, on the data image displaying portion 11, a hierarchical image showing the relationships between measurement results by measuring instruments and the calculating procedures performed using those measurement results, the relationships between calculating procedures and the calculation results of those calculating procedures, and the referenced relationships and non-referenced relationships [sic—probably a typographical error for “referencer relationships and referencee relationships”] thereof.

Note that when, as explained above, image data generated by the client computer 1 is displayed as an image, it may be displayed by the data image displaying portion 11, illustrated in FIG. 2, or may be displayed by the configuration screen displaying portion 12.

In this way, the relationships between, for example, the measurement results used in the calculating procedures and the calculation results obtained from the calculating procedures are made visible (“visualized”), making it possible to visualize also the states that produce problems such as errors in calculating formulas or illegal input signals. Consequently, the work in analyzing problems is made easier, and the time required for tracing back the causes is made shorter.

### Other Examples

Moreover, the client computer 1 may be configured so as to enable changing the image so as to place the “first floor external electric power gauges” of the R1 relationship, shown in FIG. 8, at the apex of a hierarchical structure (not shown). Doing so enables easy understanding of the calculation results that are affected, even if there is a problem in the input value.

Note that there is no limitation to the change in the image as set forth above, but rather the client computer 1 may change the image so as to place the R5 relationship for the “third-floor electric power gauges,” shown in FIG. 8, at the apex of the hierarchical structure (not shown). Moreover, the image may be changed so as to place the “No. 1 boiler fuel flow rate” of the R8 relationship in FIG. 8 at the apex of the hierarchical structure.

Furthermore, the client computer 1, may instead change the image to place, at the apex, the “office building electric power energy converting procedure,” for example, of the R11 relationship, which is in the middle of the hierarchical structure shown in FIG. 8. In this case, the parts that are on a higher-level and/or a lower-level than the “office building electric power energy converting procedure” need not necessarily be displayed. This makes it easy for the user to perform analysis work on only the desired parts of the hierarchical structure, making it possible to trace back causes more quickly.

The Example according to the present invention was explained above, using specific examples. However, the present invention is not limited to these examples. That is, even if there are design changes, by one skilled in the art, to the specific examples described above, insofar as the result is provided with the distinguishing features of the present invention, it is included within the scope of the present invention. For example, there are no limitations to that which is illustrated when it comes to the various elements, and the disposal thereof, provided in the individual examples described above, and these may be changed as appropriate. Moreover, the individual elements provided in the individual examples described above may be combined, insofar as it is technically possible, and insofar as these combinations include the distinguishing features of the present invention, they are included within the scope of the present invention.

1. A client comprising:
an information generating portion that generates first information for defining a correspondence between a measurement result by a measuring instrument and a calculating procedure executed using the measurement result, and generates second information for defining correspondence relationships between the calculating procedure and the calculation results of the calculating procedure; and
an image data generating portion that generates image data for displaying an image that defines the relationship between the first information and the second information.

2. The client as set forth in claim 1, wherein:
the image data generating portion displays an image illustration referencer relationships and referencee relationships between the first information and the second information.

3. The client as set forth in claim 1, further comprising:
a database that stores the first information and/or the second information.

4. An image data generating method comprising:
generating first information that defines a correspondence between a measurement result by a measuring instrument and a calculating procedure executed using the measurement result, and generating second information for defining a correspondence between the calculating procedure and the calculation result by the calculating procedure; and
generating image data for displaying an image that defines the relationship between the first information and the second information.
